(19) United States
(12) Patent Application Publication
(10) Pub. No.: US 2022/0009475 A1
(43) Pub. Date: Jan. 13, 2022

(54) CONTROLLER FOR VEHICLE AND CONTROL METHOD FOR VEHICLE

(71) Applicant: TOYOTA JIDOSHA KABUSHIKI KAISHA, Toyota-shi (JP)

(72) Inventors: Yoshitaka NIIMI, Toyota-shi (JP); Manabu ISHIMOTO, Miyoshi-shi (JP)

(73) Assignee: TOYOTA JIDOSHA KABUSHIKI KAISHA, Toyota-shi (JP)

(21) Appl. No.: 17/365,281

(22) Filed: Jul. 1, 2021

(30) Foreign Application Priority Data
Jul. 8, 2020 (JP) 2020-117666

(51) Int. Cl. B60W 20/10; B60K 6/26; B60K 6/24; B60W 10/06; B60W 10/08; B60K 6/387

(52) U.S. Cl. CPC B60W 20/10; B60K 6/26; B60K 6/24; B60W 10/06; B60W 2540/12; B60K 6/387; B60W 2540/10; B60W 2710/0666; B60W 2710/083; B60W 10/08

(57) ABSTRACT

A controller for a vehicle includes a target traveling torque calculating unit, a target torque calculating unit, and a torque controlling unit. The target torque calculating unit is configured to execute an increasing process that increases, on condition that the target traveling torque is greater a threshold, a ratio of the target engine torque to the target traveling torque as compared to a case in which the target traveling torque is less than or equal to the threshold. The threshold is less than a maximum output value, which is a maximum value of a torque that can be generated by the motor-generator.

### BACKGROUND

### 1. Field

The present disclosure relates to a controller for a vehicle and a control method for a vehicle.

### 2. Description of Related Art

Japanese Laid-Open Patent Publication No. 2012-091549 discloses a controller for a vehicle. The vehicle is equipped with an engine and a motor-generator as drive sources. The controller for the vehicle controls the torque of the engine and the torque of the motor-generator such that the traveling torque of the vehicle becomes a target traveling torque. The vehicle traveling torque refers to the sum of the torque of the engine and the torque of the motor-generator. The target traveling torque is a target value of the vehicle traveling torque and is calculated based on an accelerator operated amount by the driver.

When the torque of the motor-generator has reached the maximum output value, the vehicle traveling torque can be increased only by increasing the torque of the engine. In the case of an engine with a forced-induction device, if the torque of the engine is greater than or equal to a certain value, a response delay of forced induction occurs in the forced-induction device. The increase rate of the torque of the engine thus becomes lower than the increase rate of the torque of the motor-generator. As a result, the actual vehicle traveling torque may deviate from the target traveling torque.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first general aspect, a controller for a vehicle is provided. The vehicle includes an engine as a drive source, a motor-generator as a drive source, and a battery that supplies power to the motor-generator. The engine includes a forced-induction device. The controller includes a target traveling torque calculating unit, a target torque calculating unit, and a torque controlling unit. The target traveling torque calculating unit calculates a target traveling torque based on an accelerator operated amount by a driver. The target traveling torque is a target value of a traveling torque of the vehicle. The target torque calculating unit calculates a target engine torque and a target motor torque based on the target traveling torque. The target engine torque is a target value of a torque of the engine, and the target motor torque is a target value of a torque of the motor-generator. The torque controlling unit controls the torque of the engine based on the target engine torque, and controls the torque of the motor-generator based on the target motor torque. The target torque calculating unit is configured to execute an increasing process that increases, on condition that the target traveling torque is greater a threshold, a ratio of the target engine torque to the target traveling torque as compared to a case in which the target traveling torque is less than or equal to the threshold. The threshold is less than a maximum output value, which is a maximum value of a torque that can be generated by the motor-generator.

In a second general aspect, a controller for a vehicle is provided. The vehicle includes an engine as a drive source, a motor-generator as a drive source, and a battery that supplies power to the motor-generator. The engine includes a forced-induction device. The controller includes processing circuitry. The circuitry includes a target traveling torque calculating unit, a target torque calculating unit, and a torque controlling unit. The target traveling torque calculating unit calculates a target traveling torque based on an accelerator operated amount by a driver. The target traveling torque is a target value of a traveling torque of the vehicle. The target torque calculating unit calculates a target engine torque and a target motor torque based on the target traveling torque. The target engine torque is a target value of a torque of the engine, and the target motor torque is a target value of a torque of the motor-generator. The torque controlling unit controls the torque of the engine based on the target engine torque, and controls the torque of the motor-generator based on the target motor torque. The target torque calculating unit is configured to execute an increasing process that increases, on condition that the target traveling torque is greater a threshold, a ratio of the target engine torque to the target traveling torque as compared to a case in which the target traveling torque is less than or equal to the threshold. The threshold is less than a maximum output value, which is a maximum value of a torque that can be generated by the motor-generator.

In a third general aspect, a control method for a vehicle is provided. The vehicle includes an engine as a drive source, a motor-generator as a drive source, and a battery that supplies power to the motor-generator. The engine includes a forced-induction device. The control method includes: calculating a target traveling torque based on an accelerator operated amount by a driver, the target traveling torque being a target value of a traveling torque of the vehicle; calculating a target engine torque and a target motor torque based on the target traveling torque, the target engine torque being a target value of a torque of the engine, and the target motor torque being a target value of a torque of the motor-generator; controlling the torque of the engine based on the target engine torque; controlling the torque of the motor-generator based on the target motor torque; and executing an increasing process that increases, on condition that the target traveling torque is greater a threshold, a ratio of the target engine torque to the target traveling torque as compared to a case in which the target traveling torque is less than or equal to the threshold. The threshold is less than a maximum output value, which is a maximum value of a torque that can be generated by the motor-generator.

Other features and aspects will be apparent from the following detailed description, the drawings, and the claims.

### BRIEF DESCRIPTION OF THE DRAWINGS

FIG. 1 is a diagram showing the configuration of a vehicle.

FIG. 2 is a flowchart showing first torque control executed by a controller.

FIG. 3 is a flowchart showing second torque control executed by the controller.

FIG. 4 is a diagram illustrating changes in the torque of an engine in the first torque control.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

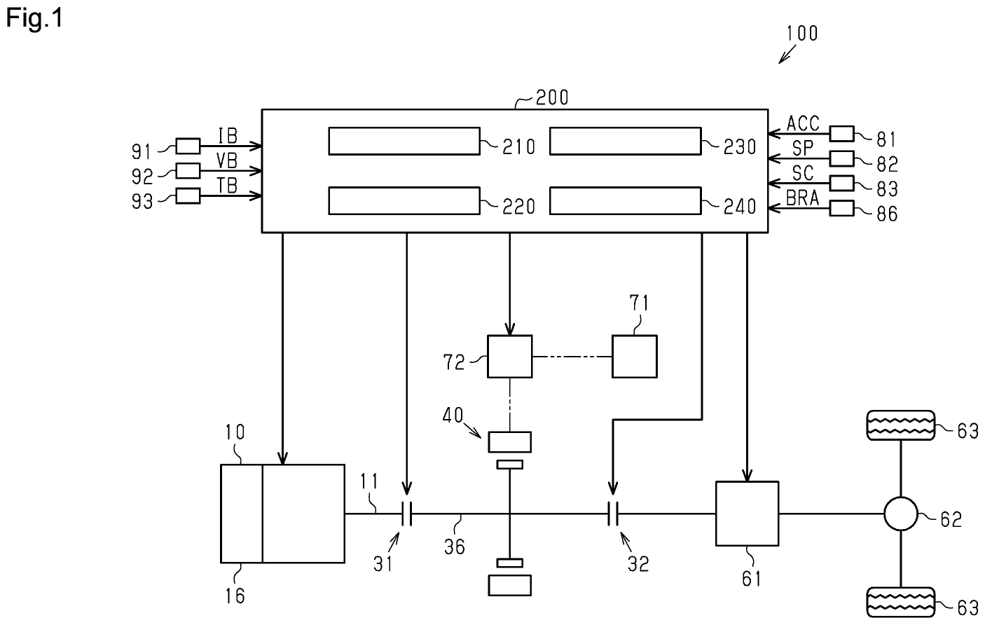

A controller 200 for a vehicle 100 according to one embodiment will now be described with reference to FIGS. 1 to 4. First, the configuration of the vehicle 100 will be described.

As shown in FIG. 1, the vehicle 100 includes a spark-ignition type engine 10. The vehicle 100 includes a motor-generator 40, which functions as both an electric motor and a generator. The vehicle 100 is a hybrid vehicle, which includes the engine 10 and the motor-generator 40 as drive sources.

The engine 10 includes a crankshaft 11. The crankshaft 11 is coupled to pistons accommodated in cylinders (not shown). The crankshaft 11 is rotated by combustion of a mixture of fuel and intake air in the cylinders. The engine 10 includes a turbocharger 16, which is a forced-induction device. The turbocharger 16 increases the pressure of intake air flowing into the cylinders by utilizing the flow of exhaust gas discharged from the cylinders. Due to the forced induction by the turbocharger 16, the pressure of intake air flowing into the cylinders increases as the amount of exhaust gas discharged from the cylinders increases.

The vehicle 100 includes a battery 71 an inverter 72. When the motor-generator 40 functions as a generator, the battery 71 stores power generated by the motor-generator 40. When the motor-generator 40 functions as an electric motor, the battery 71 supplies power to the motor-generator 40. The inverter 72 regulates the amount of power transferred between the motor-generator 40 and the battery 71.

The vehicle 100 includes a first clutch 31, a second clutch 32, a coupling shaft 36, an automatic transmission 61, a differential mechanism 62, and driven wheels 63. The crankshaft 11 is connected to the coupling shaft 36 through the first clutch 31. Hydraulic pressure that is supplied to the interior of the first clutch 31 selectively switches the state of the first clutch 31 between an engaged state and a disengaged state. The motor-generator 40 is connected to the coupling shaft 36.

The coupling shaft 36 is connected to the automatic transmission 61 through the second clutch 32. Hydraulic pressure that is supplied to the interior of the second clutch 32 selectively switches the state of the second clutch 32 between an engaged state and a disengaged state. In the present embodiment, the second clutch 32 interrupts power transmission through the power transmission path from the engine 10 to the driven wheels 63. The motor-generator 40 is located between the engine 10 and the second clutch 32 on the power transmission path.

The automatic transmission 61 is a multi-speed type that has multiple planetary gear mechanisms and discretely changes the gear ratio. The automatic transmission 61 changes the gear position, thereby switching the gear ratio. The automatic transmission 61 is connected to the driven wheels 63 through the differential mechanism 62.

The vehicle 100 includes an accelerator position sensor 81, a vehicle speed sensor 82, a crank angle sensor 83, a brake position sensor 86, a current sensor 91, a voltage sensor 92, and a temperature sensor 93.

The accelerator position sensor 81 detects an accelerator operated amount ACC, which is the operated amount (e.g. depression amount) of the accelerator pedal by the driver. The vehicle speed sensor 82 detects a vehicle speed SP, which is the speed of the vehicle 100. The crank angle sensor 83 detects a crank angle SC, which is a rotational angle of the crankshaft 11. The brake position sensor 86 detects a brake operated amount BRA, which is the operated amount (e.g. depression amount) of the brake pedal by the driver. The current sensor 91 detects a current IB, which is delivered to or from the battery 71. The voltage sensor 92 detects a voltage VB, which is the terminal-to-terminal voltage of the battery 71. The temperature sensor 93 detects a battery temperature TB, which is the temperature of the battery 71.

The vehicle 100 includes the controller 200. The controller 200 receives signals indicating the accelerator operated amount ACC, the vehicle speed SP, the crank angle SC, the brake operated amount BRA from the accelerator position sensor 81, the vehicle speed sensor 82, the crank angle sensor 83, and the brake position sensor 86, respectively. The controller 200 receives signals indicating the current IB, the voltage VB, and the battery temperature TB from the current sensor 91, the voltage sensor 92, and the temperature sensor 93, respectively.

The controller 200 calculates an engine rotation speed NE, which is the number of revolutions per unit time of the crankshaft 11, based on the crank angle SC. The controller 200 calculates the state of charge SOC of the battery 71 based on the current IB, the voltage VB, and the battery temperature TB.

The controller 200 calculates an input limitation power Win based on the state of charge SOC and the battery temperature TB. The input limitation power Win is the upper limit of the power delivered to the battery 71 from the motor-generator 40. The input limitation power Win decreases as the state of charge SOC increases. The input limitation power Win decreases as the battery temperature TB separates away from a predetermined temperature range.

The controller 200 includes a target traveling torque calculating unit 210, a target torque calculating unit 220, a permissible value setting unit 230, and a controlling unit 240. The permissible value setting unit 230 sets a permissible value Z, which is the upper limit of the torque of the engine 10.

Based on the accelerator operated amount ACC and the vehicle speed SP, the target traveling torque calculating unit 210 calculates a target traveling output, which is a target value of the output necessary for the vehicle 100 to travel. Based on the target traveling output, the target traveling torque calculating unit 210 calculates a target traveling torque TA, which is a target value of the traveling torque of the vehicle 100. The traveling torque refers to the sum of the torque of the engine 10 and the torque of the motor-generator 40.

Based on the target traveling torque TA and the state of charge SOC, the target torque calculating unit 220 determines the torque proportion of the engine 10 and the motor-generator 40. Based on the target traveling torque TA and the torque proportion, the target torque calculating unit 220 calculates a target engine torque TE, which is a target value of the torque of the engine 10. The torque of the engine 10 is torque that is delivered to the first clutch 31 from the crankshaft 11. Based on the target traveling torque TA and the torque proportion, the target torque calculating unit 220 calculates a target motor torque TM, which is a target value of the torque of the motor-generator 40. The torque of the motor-generator 40 refers to torque that is delivered to the coupling shaft 36 from the motor-generator 40 and torque that is delivered to the motor-generator 40 from the coupling shaft 36. When torque is delivered to the coupling shaft 36 from the motor-generator 40, the target motor torque TM has a positive value. In contrast, when torque is delivered to the motor-generator 40 from the coupling shaft 36, the target motor torque TM has a negative value.

The target torque calculating unit 220 calculates the target motor torque TM such that the motor-generator 40 generates power using the torque of the engine 10 when the following conditions (1) to (3) are all met. At this time, the target torque calculating unit 220 calculates the target motor torque TM such that all the torque of the engine 10 is consumed to generate power in the motor-generator 40. As a result, the power delivered to the battery 71 increases as the torque of the engine 10 increases. In this case, the target motor torque TM has a negative value.

Condition (1): the accelerator operated amount ACC is greater than 0.

Condition (2): the brake operated amount BRA is greater than 0.

Condition (3): the vehicle speed SP is 0.

The controlling unit 240 controls the engine 10 based on the target engine torque TE. Specifically, the controlling unit 240 controls the torque of the engine 10 by regulating the amount of fuel and intake air supplied to the cylinders of the engine 10. The controlling unit 240 controls the motor-generator 40 based on the target motor torque TM. Specifically, the controlling unit 240 controls the torque of the motor-generator 40 by regulating the amount of power transferred between the motor-generator 40 and the battery 71 through the inverter 72. In the present embodiment, the controlling unit 240 functions as a torque controlling unit.

The controlling unit 240 outputs a control signal to the first clutch 31 to control the state of the first clutch 31. The controlling unit 240 outputs a control signal to the second clutch 32 to control the state of the second clutch 32. The controlling unit 240 outputs a control signal to the automatic transmission 61 to perform the shift control of the automatic transmission 61.

The controller 200 may include circuitry including one or more processors that perform various processes according to computer programs (software). The controller 200 may be circuitry including one or more dedicated hardware circuits such as application specific integrated circuits (ASIC) that execute at least part of various processes, or a combination thereof. The processor includes a CPU and a memory such as a RAM and a ROM. The memory stores program codes or instructions configured to cause the CPU to execute processes. The memory, which is a computer-readable medium, includes any type of media that are accessible by general-purpose computers and dedicated computers.

Next, first torque control of the engine 10 and the motor-generator 40 executed by the controller 200 will be described. When the execution condition for second torque control, which will be discussed below, is not satisfied, the controller 200 repeatedly executes the first torque control at every predetermined cycle. The controller 200 determines that the execution condition for the second torque control is satisfied when the above-described conditions (1) to (3) are all met.

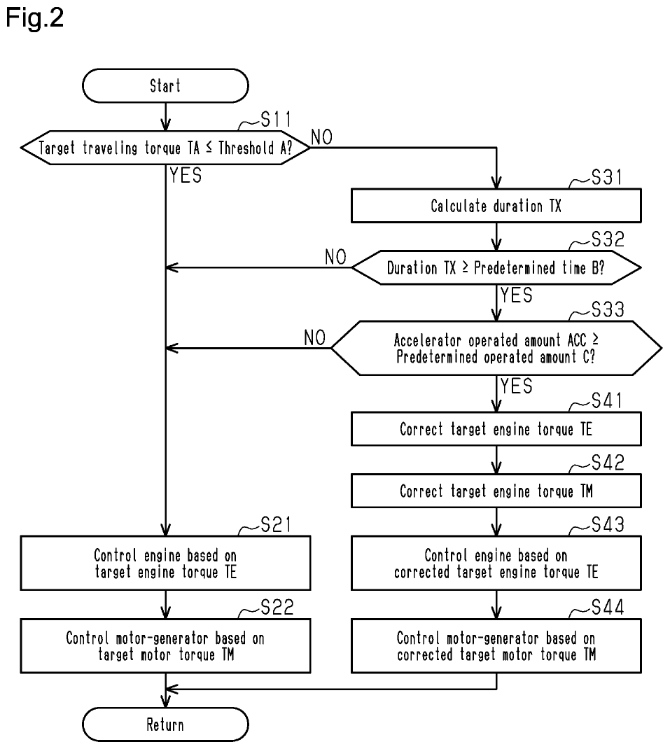

As shown in FIG. 2, when the first torque control is started, the target torque calculating unit 220 determines, in step S11, whether the target traveling torque TA is less than or equal to a threshold A, which is determined in advance. The threshold A is less than a maximum output value, which is the maximum value of the torque that can be generated by the motor-generator 40. The threshold A is also set based on the increase rate of the torque of the engine 10. Specifically, when the torque of the engine 10 is greater than or equal to a certain value, a response delay of forced induction occurs in the turbocharger 16, so that the increase rate of the torque of the engine 10 becomes less than that when the torque of the engine 10 is less than the certain value. The threshold A is a value of the torque of the engine 10 when the increase rate of the torque of the engine 10 changes, and is obtained through experiments in advance. The threshold A is equal to the above-described certain value.

If the target traveling torque TA is less than or equal to the threshold A (S11: YES), the target torque calculating unit 220 advances the process to step S21. In this case, duration TX, which will be discussed below, is reset. If the target traveling torque TA is greater than the threshold A (S11: NO), the target torque calculating unit 220 advances the process to step S31.

In step S31, the target torque calculating unit 220 calculates the duration TX, during which the target traveling torque TA is continuously greater than the threshold A. Thereafter, the target torque calculating unit 220 advances the process to step S32.

In step S32, the target torque calculating unit 220 determines whether the duration TX is longer than or equal to a predetermined time B. The predetermined time B is used to determine whether a state in which the target traveling torque TA is greater than the threshold A has continued for a certain period of time. The predetermined time B is, for example, a few seconds. If the duration TX is shorter than the predetermined time B (S32: NO), the target torque calculating unit 220 advances the process to step S21. If the duration TX is longer than or equal to the predetermined time B (S32: YES), the target torque calculating unit 220 advances the process to step S33.

In step S33, the target torque calculating unit 220 determines whether the accelerator operated amount ACC is greater than or equal to a predetermined operated amount C. The predetermined operated amount C is used to determine whether the accelerator operated amount ACC is above a threshold. If the accelerator operated amount ACC is less than the predetermined operated amount C (S33: NO), the target torque calculating unit 220 advances the process to step S21.

The target torque calculating unit 220 advances the process to step S21 when the decision outcome of step S11 is affirmative, when the decision outcome of step S32 is negative, or when the decision outcome of step S33 is negative.

In step S21, the controlling unit 240 controls the engine 10 such that the torque of the engine 10 becomes equal to the target engine torque TE. Thereafter, the controlling unit 240 advances the process to step S22. In step S22, the controlling unit 240 controls the motor-generator 40 such that the torque of the motor-generator 40 becomes equal to the target motor torque TM. Thereafter, the controlling unit 240 ends the current cycle of the first torque control.

If the accelerator operated amount ACC is greater than or equal to the predetermined operated amount C in step S33 (S33: YES), the target torque calculating unit 220 advances the process to step S41.

In step S41, the target torque calculating unit 220 corrects the target engine torque TE such that the target engine torque TE increases. Specifically, the target torque calculating unit 220 adds a predetermined amount to the target engine torque TE, which has not been corrected, thereby calculating the corrected target engine torque TE. Accordingly, the ratio of the target engine torque TE to the target traveling torque TA is increased as compared to a case in which the target engine torque TE is not corrected. The process of step S41 is one example of an increasing process. Thereafter, the target torque calculating unit 220 advances the process to step S42.

In step S42, the target torque calculating unit 220 corrects the target motor torque TM such that the target motor torque TM decreases. Specifically, the target torque calculating unit 220 subtracts a predetermined amount from the target motor torque TM, which has not been corrected, thereby calculating the corrected target motor torque TM. The predetermined amount of step S42 is equal to the predetermined amount of step S41. Thereafter, the target torque calculating unit 220 advances the process to step S43.

In step S43, the controlling unit 240 controls the engine 10 such that the torque of the engine 10 becomes equal to the corrected target engine torque TE, which has been calculated in step S41. Thereafter, the controlling unit 240 advances the process to step S44. In step S44, the controlling unit 240 controls the motor-generator 40 such that the torque of the motor-generator 40 becomes equal to the corrected target motor torque TM, which has been calculated in step S42. Thereafter, the controlling unit 240 ends the current cycle of the first torque control.

Next, the second torque control of the engine 10 and the motor-generator 40 executed by the controller 200 will be described. When the execution condition for the second torque control is satisfied, the controller 200 repeatedly executes the second torque control at every predetermined cycle.

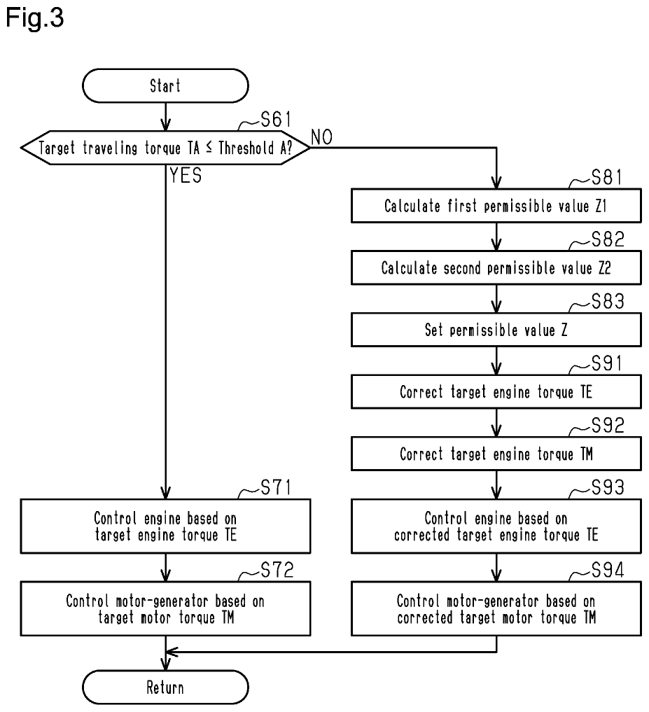

As shown in FIG. 3, when the second torque control is started, the target torque calculating unit 220 determines, in step S61, whether the target traveling torque TA is less than or equal to the threshold A, which is determined in advance. If the target traveling torque TA is less than or equal to the threshold A (S61: YES), the target torque calculating unit 220 advances the process to step S71.

In step S71, the controlling unit 240 controls the engine 10 such that the torque of the engine 10 becomes equal to the target engine torque TE. Thereafter, the controlling unit 240 advances the process to step S72. In step S72, the controlling unit 240 controls the motor-generator 40 such that the torque of the motor-generator 40 becomes equal to the target motor torque TM. Thereafter, the controlling unit 240 ends the current cycle of the second torque control.

If the target traveling torque TA is greater than the threshold A in step S61 (S61: NO), the target torque calculating unit 220 advances the process to step S81.

In step S81, the permissible value setting unit 230 calculates a first permissible value Z1 based on a maximum input value, which is the maximum value of the torque that can be delivered to the motor-generator 40. Specifically, the permissible value setting unit 230 sets the first permissible value Z1 to the maximum input value. Thereafter, the permissible value setting unit 230 advances the process to step S82.

In step S82, the permissible value setting unit 230 calculates a second permissible value Z2 based on the input limitation power Win. As described above, the power generated by the motor-generator 40 using the torque of the engine 10 is delivered to the battery 71 when the three conditions of the execution condition for the second torque control are met. In this case, the power delivered to the battery 71 increases as the torque of the engine 10 increases. Accordingly, the second permissible value Z2 is calculated as the upper limit of the torque of the engine 10 used to limit the power delivered to the battery 71 to a value less than or equal to the input limitation power Win. The second permissible value Z2 decreases as the input limitation power Win decreases. Thereafter, the permissible value setting unit 230 advances the process to step S83.

In step S83, the permissible value setting unit 230 sets the permissible value Z based on the first permissible value Z1 and the second permissible value Z2. Specifically, the permissible value setting unit 230 sets the permissible value Z to the smaller one of the first permissible value Z1 and the second permissible value Z2. Thereafter, the permissible value setting unit 230 advances the process to step S91.

In step S91, the target torque calculating unit 220 corrects the target engine torque TE such that the target engine torque TE increases. Specifically, the target torque calculating unit 220 adds a predetermined amount to the target engine torque TE, which has not been corrected, thereby calculating the corrected target engine torque TE. Accordingly, the ratio of the target engine torque TE to the target traveling torque TA is increased as compared to a case in which the target engine torque TE is not corrected. The process of step S91 is one example of an increasing process.

If the value obtained by adding the predetermined amount to the target engine torque TE, which has not been corrected, is greater than the permissible value Z, the target torque calculating unit 220 sets the corrected target engine torque TE to the permissible value Z. That is, the target torque calculating unit 220 corrects the target engine torque TE such that the corrected target engine torque TE does not exceed the permissible value Z. After the process of step S91, the target torque calculating unit 220 advances the process to step S92.

In step S92, the target torque calculating unit 220 corrects the target motor torque TM such that the target motor torque TM decreases. Specifically, the target torque calculating unit 220 subtracts a predetermined amount from the target motor torque TM, which has not been corrected, thereby calculating the corrected target motor torque TM. The predetermined amount of step S92 is equal to the predetermined amount of step S91.

In a case in which the corrected target engine torque TE is set to the permissible value Z in step S91, the target torque calculating unit 220 sets, in step S92, the corrected target motor torque TM to the value obtained by subtracting the corrected target engine torque TE from the target traveling torque TA. After step S92, the target torque calculating unit 220 advances the process to step S93.

In step S93, the controlling unit 240 controls the engine 10 such that the torque of the engine 10 becomes equal to the corrected target engine torque TE, which has been calculated in step S91. Thereafter, the controlling unit 240 advances the process to step S94. In step S94, the controlling unit 240 controls the motor-generator 40 such that the torque of the motor-generator 40 becomes equal to the corrected target motor torque TM, which has been calculated in step S92. Thereafter, the controlling unit 240 ends the current cycle of the second torque control.

An operation and advantages of the present embodiment will now be described.

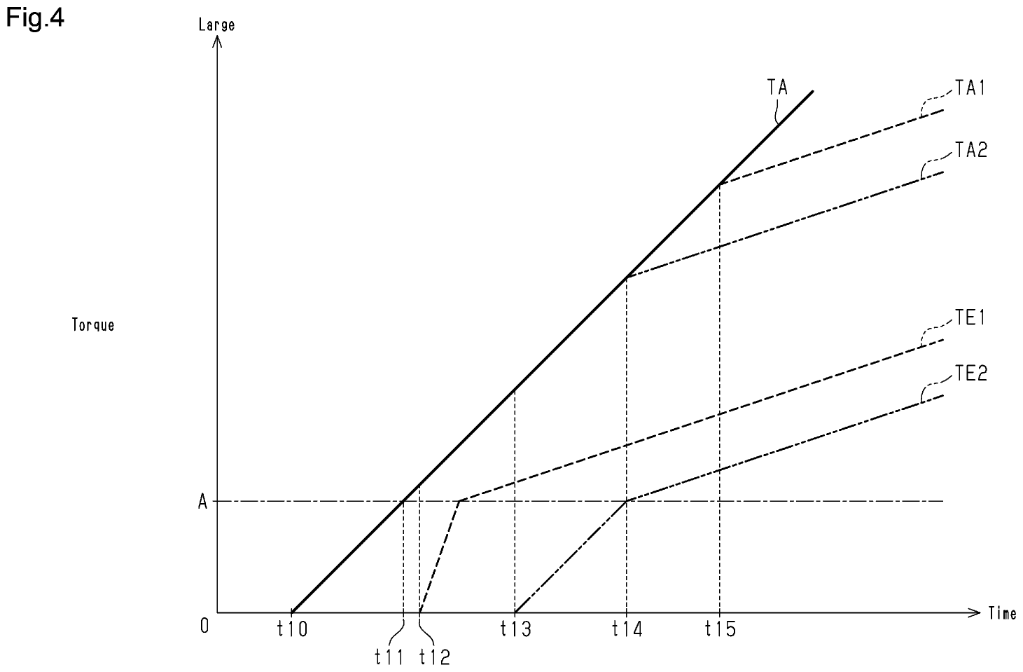

(1) The example shown in FIG. 4 assumes that the target traveling torque TA increases progressively over time after a point in time t10. The example also assumes that, after the point in time t10, the accelerator operated amount ACC is greater than 0, and the brake operated amount BRA is 0. The example further assumes that the accelerator operated amount ACC is greater than or equal to the predetermined operated amount C at and after a point in time t11.

In a comparative example represented by long-dash double-short-dash lines in FIG. 4, the torque of the motor-generator 40 increases progressively during a period from the point in time t10 to a point in time t13, such that an actual traveling torque TA2, which is the actual traveling torque of the vehicle 100, becomes the target traveling torque TA. During the period from the point in time t10 to the point in time t13, the torque of the engine 10 is maintained at 0. The torque of the motor-generator 40 reaches the maximum output value at the point in time t13. At and after the point in time t13, the torque of the engine 10 increases progressively such that the actual traveling torque TA2 of the vehicle 100 becomes the target traveling torque TA. However, when the torque of the engine 10 reaches or exceeds the certain value at a point in time t14, a response delay of forced induction occurs in the turbocharger 16. This reduces the increase rate of the torque of the engine 10. As a result, the actual traveling torque TA2 deviates from the target traveling torque TA at and after the point in time t14.

In this respect, the present embodiment maintains a state in which the target traveling torque TA is greater than the threshold A at and after the point in time t11. When the duration TX becomes greater than or equal to the predetermined time B at a point in time t12, the target engine torque TE is calculated such that the ratio of the target engine torque TE to the target traveling torque TA increases. Accordingly, at and after the point in time t12, an actual engine torque TE1, which is the actual torque of the engine 10 corresponding to the target traveling torque TA, becomes greater than an actual engine torque TE2, which is the actual torque of the engine 10 corresponding to the target traveling torque TA in the comparative example, as shown in FIG. 4. On the other hand, since the torque of the motor-generator 40 is suppressed to a small value, the torque of the motor-generator 40 is prevented from reaching the maximum output value. This expands opportunities for the traveling torque of the vehicle 100 to be adjusted using the torque of the motor-generator 40. This reduces opportunities for the traveling torque of the vehicle 100 to be adjusted using solely the torque of the engine 10, the increase rate of which is lower than that of the torque of the motor-generator 40. As a result, the actual traveling torque TA1 of the vehicle 100 is prevented from deviating from the target traveling torque TA.

On the other hand, in a case in which the target traveling torque TA is less than or equal to the threshold A, there is no limitation to the ratio of the target engine torque TE to the target traveling torque TA, unlike the case in which the target traveling torque TA is greater than the threshold A. This allows, for example, the target engine torque TE and the target motor torque TM to be calculated separately such that the fuel consumption of the engine 10 is minimized.

(2) The target traveling torque TA may be temporarily greater than the threshold A depending on the operation of the accelerator pedal by the driver. If the ratio of the target engine torque TE to the target traveling torque TA were increased when the target traveling torque TA is temporarily greater than the threshold A, the ratio of the target engine torque TE to the target traveling torque TA would be frequently restricted solely due to the temporary increase of the target traveling torque TA.

In this respect, the present embodiment increases the ratio of the target engine torque TE to the target traveling torque TA on condition that the duration TX is longer than or equal to the predetermined time B. Thus, the ratio of the target engine torque TE to the target traveling torque TA is not increased due to the temporary increase in the target traveling torque TA. The ratio of the target engine torque TE to the target traveling torque TA is therefore unlikely to be restricted. This allows, for example, the target engine torque TE and the target motor torque TM to be calculated such that the fuel consumption is minimized.

(3) The target traveling torque TA is greater in a case in which the accelerator operated amount ACC is greater than or equal to the predetermined operated amount C, than in a case in which the accelerator operated amount ACC is less than the predetermined operated amount C. If the target traveling torque TA increases, it is more likely that the torque of the motor-generator 40 will reach the maximum output value.

In this respect, the present embodiment increases the ratio of the target engine torque TE to the target traveling torque TA on condition that the accelerator operated amount ACC is greater than or equal to the predetermined operated amount C. That is, the torque of the engine 10 is increased in anticipation a situation in which the torque of the motor-generator 40 is likely to reach the maximum output value. As a result, the ratio of the target engine torque TE to the target traveling torque TA is unlikely to be restricted. The actual traveling torque TA1 is thus prevented from deviating from the target traveling torque TA.

(4) In a case in which the vehicle speed SP is 0, and the accelerator operated amount ACC and the brake operated amount BRA are both greater than 0, it is likely that an abrupt acceleration of the vehicle 100 will be requested when the driver subsequently causes the brake operated amount BRA to be 0. In this case, since the target traveling torque TA is increased, the torque of the motor-generator 40 is highly likely to reach the maximum output value.

In this respect, the present embodiment increases the ratio of the target engine torque TE to the target traveling torque TA in a case in which the target traveling torque TA is greater than the threshold A when the execution condition for the second torque control is met (i.e. the vehicle speed SP is 0, and the accelerator operated amount ACC and the brake operated amount BRA are both greater than 0). That is, the torque of the engine 10 is increased in anticipation a situation in which the torque of the motor-generator 40 is likely to reach the maximum output value. As a result, the ratio of the target engine torque TE to the target traveling torque TA is unlikely to be restricted. The actual traveling torque TA1 is thus prevented from deviating from the target traveling torque TA.

(5) In a case in which the vehicle speed SP is 0, and the accelerator operated amount ACC and the brake operated amount BRA are both greater than 0, the torque of the engine 10 may be delivered to the second clutch 32 despite the fact that the torque of the engine 10 does not need to be transmitted to the driven wheels 63. In this case, an increase in the torque delivered to the second clutch 32 promotes wear of the second clutch 32.

In this respect, the motor-generator 40 is controlled such that the power generation of the motor-generator 40 is performed using the torque of the engine 10 when the execution condition for the second torque control is met, and the target traveling torque TA is greater than the threshold A. This limits the torque delivered to second clutch 32 as compared to a case in which the motor-generator 40 does not generate power using the torque of the engine 10. This suppresses progression of wear of the second clutch 32.

(6) The target torque calculating unit 220 calculates the target engine torque TE such that the target engine torque TE does not exceed the permissible value Z, which is set by the permissible value setting unit 230. This prevents the torque of the engine 10 from exceeding the permissible value Z. The torque delivered to the second clutch 32 is thus unlikely to be excessive. This suppresses progression of wear of the second clutch 32.

(7) The permissible value setting unit 230 calculates the first permissible value Z1 based on the maximum input value, which is the maximum value of the torque that can be delivered to the motor-generator 40. Also, the permissible value setting unit 230 calculates the second permissible value Z2 based on the input limitation power Win. The permissible value setting unit 230 sets the permissible value Z to the smaller one of the first permissible value Z1 and the second permissible value Z2. This prevents the torque delivered to the motor-generator 40 from exceeding the maximum input value. This also prevents the power delivered to the battery 71 from being exceeding the input limitation power Win. As a result, the torque delivered to the motor-generator 40 is unlikely to be excessive. The power delivered to the battery 71 is prevented from being excessive.

The present embodiment may be modified as follows. The present embodiment and the following modifications can be combined as long as the combined modifications remain technically consistent with each other.

The first torque control may be changed. For example, the threshold A in the process of step S11 does not necessarily need to be equal to the value of the torque when the increase rate of the torque of the engine 10 changes. That is, the threshold A may be greater than or less than the value of the torque when the increase rate of the torque of the engine 10 changes. In this case also, it suffices if the threshold A is less than a maximum output value, which is the maximum value of the torque that can be generated by the motor-generator 40.

For example, the processes of step S31 and step S32 are not necessarily required. That is, when the decision outcome of step S11 is negative, the process may be advanced to step S33. Specifically, the processes of step S31 and step S32 may be omitted if the ratio of the target engine torque TE to the target traveling torque TA is permitted to be restricted due to a temporary increase in the target traveling torque TA.

For example, the process of step S33 is not necessarily required. That is, when the decision outcome of step S32 is affirmative, the process may be advanced to step S41. Specifically, when the value of the threshold A is relatively large, it is possible to determine whether the torque of the motor-generator 40 is likely to reach the maximum output value through the process of step S11, regardless of the value of the accelerator operated amount ACC.

Also, for example, the processes of step S31 to step S33 may be omitted, and the process may be advanced to step S41 when the decision outcome of step S11 is negative.

For example, the configuration for correction in the process of step S41 may be changed. Specifically, the target torque calculating unit 220 may change the torque proportion of the engine 10 and the motor-generator 40 so as to increase the ratio of the target engine torque TE to the target traveling torque TA. Likewise, the configuration for correction in the process of step S42 may be changed.

The second torque control may be changed. For example, the threshold A in the process of step S61 does not necessarily need to be equal to the value of the torque when the increase rate of the torque of the engine 10 changes. That is, the threshold A may be greater than or less than the value of the torque when the increase rate of the torque of the engine 10 changes. The threshold A in the process of step S61 does not necessarily need to be equal to the threshold A of step S11.

Also, the process of step S81 is not necessarily required. That is, when the decision outcome of step S61 is negative, the process may be advanced to step S82. Specifically, the process of step S81 may be omitted if the torque of the engine 10 is relatively small in a case in which the motor-generator 40 generates power using the torque of the engine 10. In this case, the permissible value setting unit 230 simply needs to set the permissible value Z to the second permissible value Z2 in step S83.

For example, the process step S82 is not necessarily required, and the process may be advanced to step S83 after the process of step S81. Specifically, the process of step S82 may be omitted when the power that is actually delivered to the battery 71 is lower to some extent than the input limitation power Win. In this case, the permissible value setting unit 230 simply needs to set the permissible value Z to the first permissible value Z1 in step S83.

Also, the processes of step S81 to step S83 are not necessarily required. When the decision outcome of step S61 is negative, the process may be advanced to step S91. In this case, the permissible value setting unit 230 may be omitted.

For example, the configuration for correction in the process of step S91 may be changed. Specifically, the target torque calculating unit 220 may change the torque proportion of the engine 10 and the motor-generator 40 so as to increase the ratio of the target engine torque TE to the target traveling torque TA. Likewise, the configuration for correction in the process of step S92 may be changed.

The execution condition for the second torque control may be changed. For example, the controller 200 may determine that the execution condition for the second torque control is satisfied when the condition (1) and the condition (2) are met, regardless of the condition (3).

One of the first torque control and the second torque control may be omitted. For example, when the second torque control is omitted, the controller 200 may repeatedly execute the first torque control at every predetermined cycle regardless whether the execution condition for the second torque control is met.

The forced-induction device is not limited to the turbocharger 16, but may be changed to a supercharger.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for a vehicle, wherein
the vehicle includes:
an engine as a drive source;
a motor-generator as a drive source; and
a battery that supplies power to the motor-generator,
the engine includes a forced-induction device,
the controller comprising:
a target traveling torque calculating unit that calculates a target traveling torque based on an accelerator operated amount by a driver, the target traveling torque being a target value of a traveling torque of the vehicle;
a target torque calculating unit that calculates a target engine torque and a target motor torque based on the target traveling torque, the target engine torque being a target value of a torque of the engine, and the target motor torque being a target value of a torque of the motor-generator; and
a torque controlling unit that controls the torque of the engine based on the target engine torque, and controls the torque of the motor-generator based on the target motor torque, wherein
the target torque calculating unit is configured to execute an increasing process that increases, on condition that the target traveling torque is greater a threshold, a ratio of the target engine torque to the target traveling torque as compared to a case in which the target traveling torque is less than or equal to the threshold, and
the threshold is less than a maximum output value, which is a maximum value of a torque that can be generated by the motor-generator.

2. The controller for a vehicle according to claim 1, wherein the target torque calculating unit is configured to execute the increasing process on condition that a state in which the target traveling torque is greater than the threshold has continued for a predetermined time or longer.

3. The controller for a vehicle according to claim 1, wherein the target torque calculating unit is configured to execute the increasing process on condition that the target traveling torque is greater than the threshold, and that the accelerator operated amount is greater than or equal to a predetermined operated amount.

4. The controller for a vehicle according to claim 1, wherein the target torque calculating unit is configured to execute the increasing process on condition that the target traveling torque is greater than the threshold, and that the accelerator operated amount and a brake operated amount by the driver are both greater than 0.

5. The controller for a vehicle according to claim 4, wherein
the vehicle includes:
a driven wheel; and
a clutch that interrupts power transmission through a power transmission path from the engine to the driven wheel,
the controller further comprising a permissible value setting unit that sets a permissible value, which is an upper limit of the torque of the engine,
wherein the target torque calculating unit is configured to calculate the target engine torque such that the target engine torque does not exceed the permissible value.

6. The controller for a vehicle according to claim 5, wherein
the motor-generator is located between the engine and the clutch on the power transmission path, and
the torque controlling unit is configured to, when the target traveling torque is greater than the threshold, and the accelerator operated amount and the brake operated amount are both greater than 0, execute the increasing process and control the motor-generator such that power generation of the motor-generator is performed using the torque of the engine.

7. The controller for a vehicle according to claim 6, wherein the permissible value setting unit is configured to set the permissible value based on at least one of a maximum input value, which is a maximum value of a torque that can be delivered to the motor-generator, or an input limitation power, which is a limit value of a power distributed to the battery.

8. The controller for a vehicle according to claim 7, wherein
the permissible value setting unit is configured to
calculate a first permissible value based on the maximum input value,
calculate a second permissible value based on the input limitation power, and
set the permissible value to the smaller one of the first permissible value or the second permissible value.

9. A controller for a vehicle, wherein
the vehicle includes:
an engine as a drive source;
a motor-generator as a drive source; and
a battery that supplies power to the motor-generator,
the engine includes a forced-induction device,
the controller comprising processing circuitry, wherein
the circuitry includes:
a target traveling torque calculating unit that calculates a target traveling torque based on an accelerator operated amount by a driver, the target traveling torque being a target value of a traveling torque of the vehicle;
a target torque calculating unit that calculates a target engine torque and a target motor torque based on the target traveling torque, the target engine torque being a target value of a torque of the engine, and the target motor torque being a target value of a torque of the motor-generator; and
a torque controlling unit that controls the torque of the engine based on the target engine torque, and controls the torque of the motor-generator based on the target motor torque,
the target torque calculating unit is configured to execute an increasing process that increases, on condition that the target traveling torque is greater a threshold, a ratio of the target engine torque to the target traveling torque as compared to a case in which the target traveling torque is less than or equal to the threshold, and
the threshold is less than a maximum output value, which is a maximum value of a torque that can be generated by the motor-generator.

10. A control method for a vehicle, wherein
the vehicle includes:
an engine as a drive source;
a motor-generator as a drive source; and
a battery that supplies power to the motor-generator,
the engine includes a forced-induction device,
the control method comprising:
calculating a target traveling torque based on an accelerator operated amount by a driver, the target traveling torque being a target value of a traveling torque of the vehicle;
calculating a target engine torque and a target motor torque based on the target traveling torque, the target engine torque being a target value of a torque of the engine, and the target motor torque being a target value of a torque of the motor-generator;
controlling the torque of the engine based on the target engine torque;
controlling the torque of the motor-generator based on the target motor torque; and
executing an increasing process that increases, on condition that the target traveling torque is greater a threshold, a ratio of the target engine torque to the target traveling torque as compared to a case in which the target traveling torque is less than or equal to the threshold,
wherein the threshold is less than a maximum output value, which is a maximum value of a torque that can be generated by the motor-generator.
